(19) United States
(12) Patent Application Publication
(10) Pub. No.: US 2025/0256504 A1
(43) Pub. Date: Aug. 14, 2025

(54) INFORMATION PROCESSING APPARATUS, INFORMATION PROCESSING METHOD, AND NON-TRANSITORY RECORDING MEDIUM

(71) Applicant: Paru KONDO, Kanagawa (JP)

(72) Inventor: Paru KONDO, Kanagawa (JP)

(73) Assignee: Ricoh Company, Ltd., Tokyo (JP)

(21) Appl. No.: 19/007,960

(22) Filed: Jan. 2, 2025

(30) Foreign Application Priority Data
Feb. 14, 2024 (JP) 2024-020081

(51) Int. Cl. B41J 2/045; B41J 2/21; B41J 29/00; G06K 15/00; G06K 15/02

(52) U.S. Cl. CPC B41J 2/04558; B41J 2/04586; B41J 2/2121; B41J 29/00; G06K 15/027; G06K 15/407; G06K 2215/101

(57) ABSTRACT

An information processing apparatus includes circuitry to obtain a measurement result of an amount of ink drop discharged from one or more nozzles of an inkjet head in response to receiving a signal for starting a restriction on a total amount of ink drop, create a table used for converting a gradation value into the amount of ink drop based on the measurement result of the amount of ink drop, and restrict a total amount of ink drop corresponding to the gradation value using the table.

### CROSS-REFERENCE TO RELATED APPLICATIONS

This patent application is based on and claims priority pursuant to 35 U.S.C. § 119(a) to Japanese Patent Application No. 2024-020081, filed on Feb. 14, 2024, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

As one method for restricting the total amount of ink drop used in printing by an image forming apparatus such as an inkjet printer, a method has been developed in which the total amount of ink drop is restricted after the gradation value is converted into the amount of ink drop.

### SUMMARY

In one aspect, an information processing apparatus includes circuitry to obtain a measurement result of an amount of ink drop discharged from one or more nozzles of an inkjet head in response to receiving a signal for starting a restriction on a total amount of ink drop, create a table used for converting a gradation value into the amount of ink drop based on the measurement result of the amount of ink drop, and restrict a total amount of ink drop corresponding to the gradation value using the table.

In another aspect, an information processing includes obtaining a measurement result of an amount of ink drop discharged from one or more nozzles of an inkjet head in response to receiving a signal for starting a restriction on a total amount of ink drop, creating a table used for converting a gradation value into the amount of ink drop based on the measurement result of the amount of ink drop, and restricting a total amount of ink drop corresponding to the gradation value using the table.

In another aspect, a non-transitory recording medium stores a plurality of program codes which, when executed by one or more processors, causes the one or more processors to perform a method including obtaining a measurement result of an amount of ink drop discharged from one or more nozzles of an inkjet head in response to receiving a signal for starting a restriction on a total amount of ink drop, creating a table used for converting a gradation value into the amount of ink drop based on the measurement result of the amount of ink drop, and restricting a total amount of ink drop corresponding to the gradation value using the table.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a graph illustrating a relationship between a gradation value and an amount of ink drop to reproduce the color of the gradation value;

FIG. 2 is a diagram illustrating an amount of ink drop when the total amount of ink drop is restricted based on a gradation value;

FIG. 3 is a diagram illustrating an amount of ink drop when the total amount of ink drop is restricted after a gradation value is converted into the amount of ink drop;

FIG. 4 is a diagram illustrating a configuration of an image forming system;

FIG. 5 is a schematic diagram illustrating the processing executed by a host computer and an information processing apparatus in an image forming system;

FIG. 6 is a diagram illustrating a configuration of a color conversion processing unit of an information processing apparatus;

FIG. 7 is a diagram illustrating a configuration of an amount of ink drop measurement result obtaining unit of an information processing apparatus;

FIG. 8 is a diagram illustrating a method for specifying a measurement gradation value and the number of times of measurement in an information processing apparatus; and

FIG. 9 is a diagram illustrating display of a change in ink amount in an information processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a non-transitory recording medium according to embodiments of the present disclosure are described in detail below with reference to the accompanying drawings.

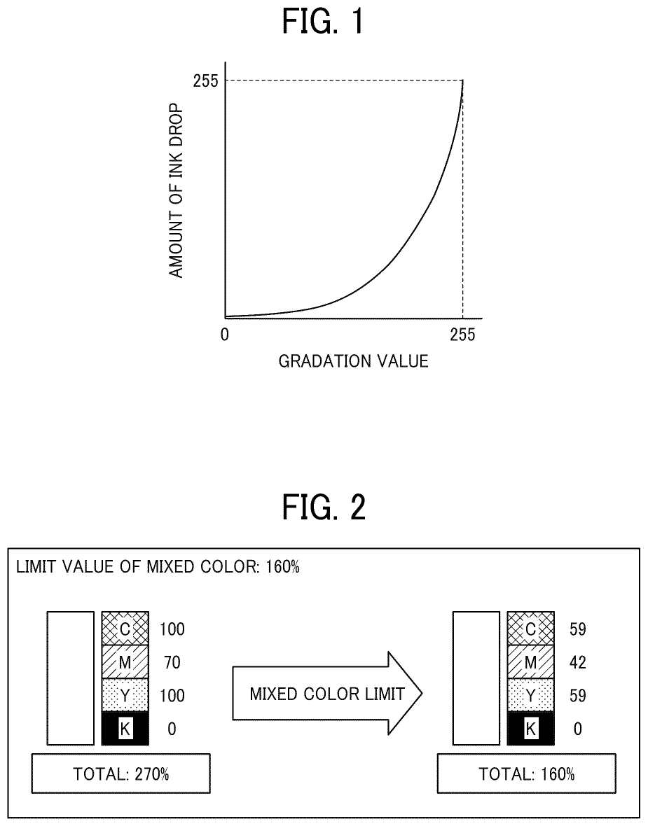

FIG. 1 is a graph illustrating a relationship between a gradation value and an amount of ink drop to reproduce the color of the gradation value. In FIG. 1, the vertical axis represents the amount of ink drop, and the horizontal axis represents the gradation value. As illustrated in FIG. 1, the relationship between the gradation value and the amount of ink drop is not linear. Accordingly, if the total amount of ink drop is restricted based on the gradation value, the amount of ink smaller than the amount of ink that should originally be applied is applied.

FIG. 2 is a diagram illustrating the amount of ink drop when the total amount of ink drop is restricted based on the gradation value. It is assumed that the total amount of ink drop is restricted based on the gradation value without converting the amount of ink drop into the gradation value. For example, in the case where the total amount of ink drop is restricted at an ink limit value of 160% of mixed color, the amount of ink smaller than the amount of ink that should originally be applied is applied as illustrated in FIG. 2. In FIG. 2, the ink limit value of mixed color is the total value of the ink limit value of each of cyan, magenta, yellow, and black (CMYK) colors. The ink limit value is a numerical value that indicates the upper limit value of the amount of ink in percentage. The upper limit value may be set by an operator or automatically determined based on a measurement result.

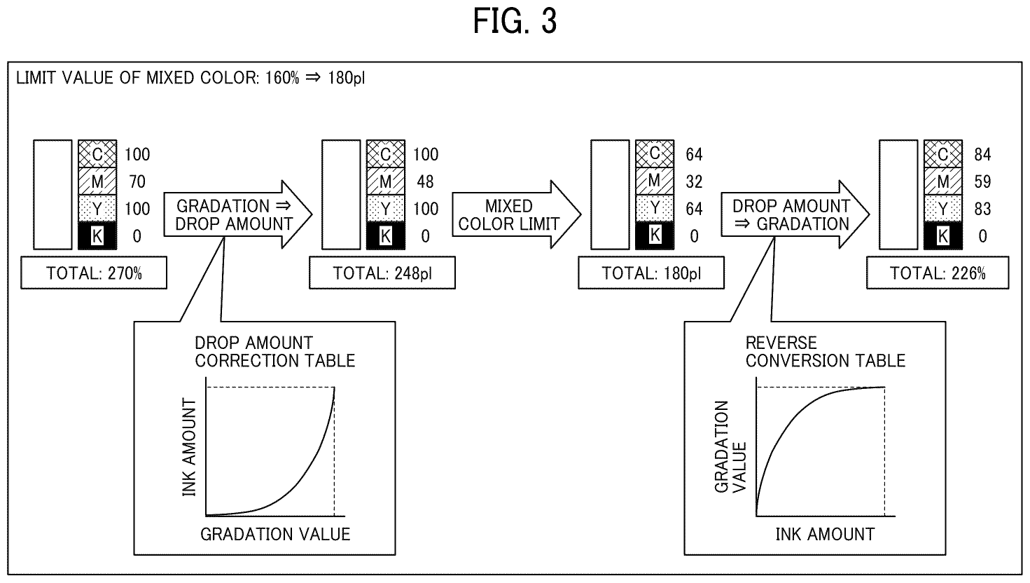

FIG. 3 is a diagram illustrating the amount of ink drop when the total amount of ink drop is restricted after the gradation value is converted into the amount of ink drop. As illustrated in FIG. 3, a greater amount of ink is applied to a sheet when the total amount of ink drop is restricted after the gradation value is converted into the amount of ink drop, as compared with the case where the total amount of ink drop is restricted based on the gradation value. In the case where the amount of ink is small, the range of color reproduction is narrowed. Accordingly, as illustrated in FIG. 3, the range of color reproduction is expanded to the maximum extent by restricting the total amount of ink drop (for example, restricting the total amount of ink drop in an amount of 180 pl of ink corresponding to the ink limit value of 160% of mixed color) after the gradation value is converted into the amount of ink drop.

According to the technique in the art, the gradation value is converted into the amount of ink drop based on a predetermined fixed value. However, the amount of ink drop with respect to the gradation value is not necessarily constant due to, for example, the environment such as air temperature, humidity, and atmospheric pressure, individual differences of nozzles of an inkjet head caused at the time of manufacturing, and changes over time. In the case where the predetermined fixed value is used, the factors described above are not addressed. As a result, a difference occurs between the amount of ink obtained based on the predetermined fixed value and the actual amount of ink.

The difference between the amount of ink drop in a look-up table (LUT) and the actual amount of ink directly affects the image quality when the total amount of ink drop is restricted. The smaller the difference between the amount of ink drop and the actual amount of ink, the wider the range of color reproduction that can be expanded. As a result, the image quality increases. When the amount of ink drop is smaller than the actual amount of ink, the range of color reproduction is narrowed because the total amount of ink drop is excessively restricted. When the actual amount of ink is greater than the amount of ink drop, the ink is excessively adhered to the sheet. As a result, the sheet is conveyed without the ink being dried, which causes a failure of the printer, or a degradation in image quality due to bleeding or bleed-through of the ink. With the technique in the art, the accuracy of the amount of ink drop (the difference between the amount of ink drop and the actual amount of ink) is insufficient, and thus the image quality is degraded.

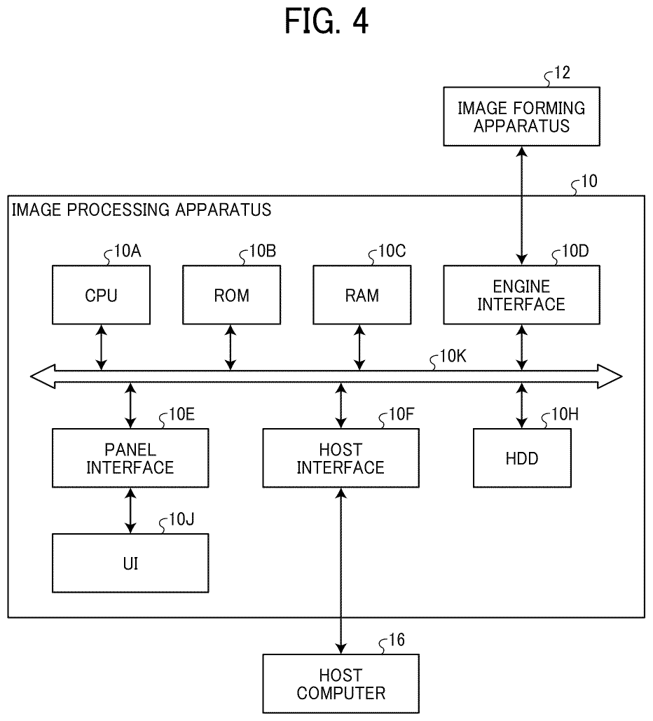

FIG. 4 is a diagram illustrating a configuration of an image forming system. The image forming system includes an information processing apparatus 10, an image forming apparatus 12, and a host computer 16. The host computer 16 and the image forming apparatus 12 are communicably connected to the information processing apparatus 10.

The information processing apparatus 10 receives a rendering command including print data from the host computer 16, converts the print data into print data in a format that can be processed by the image forming apparatus 12, and outputs the converted print data to the image forming apparatus 12. Multiple image forming apparatuses 12 may be connected to the information processing apparatus 10. Further, the image forming apparatus 12 may be directly connected to the host computer 16.

The information processing apparatus 10 includes a central processing unit (CPU) 10A, a read-only memory (ROM) 10B, a random-access memory (RAM) 10C, an engine interface 10D, a panel interface 10E, a host interface 10F, a hard disk drive (HDD) 10H, and a user interface (UI) 10J.

The CPU 10A executes a control program stored in a storage device and controls the entire operation of the information processing apparatus 10. The ROM 10B, the RAM 10C, and the HDD 10H are examples of the storage device. The ROM 10B stores fixed programs. The RAM 10C has a storage area that serves as a work area for the CPU 10A. The HDD 10H stores, for example, various control programs, measurement data, and conversion tables.

The panel interface 10E, which may be implemented by an interface circuit, is an interface for connection with the UI 10J. The panel interface 10E displays a screen instructed by the CPU 10A on the UI 10J, and transmits an operation instruction received on the UI 10J to the CPU 10A.

The UI 10J (an example of a user interface (UI)) includes a display that displays a setting screen used for setting various settings for the image forming apparatus 12, and an input receiving device that receives input of various settings from the operator.

The host interface 10F, which may be implemented by an interface circuit, is communicably connected to the host computer 16 and receives the rendering command from the host computer 16.

The engine interface 10D, which may be implemented by an interface circuit, outputs the converted print data to the image forming apparatus 12 in response to an output instruction from the CPU 10A.

The image forming apparatus 12 includes an image forming section. The image forming apparatus 12 includes, for example, an image forming section employing an inkjet printing system. The image forming apparatus 12 forms an image on a medium with the image forming section using the print data generated by the information processing apparatus 10. The image forming section includes the inkjet head.

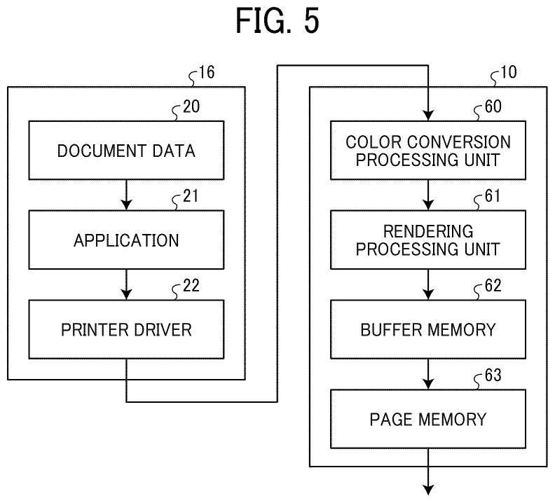

FIG. 5 is a schematic diagram illustrating the processing executed by the host computer 16 and the information processing apparatus 10 in the image forming system. The host computer 16 includes, for example, various kinds of applications 21 for generating document data 20. The host computer 16 also includes a printer driver 22. In response to receiving an instruction to execute print processing of the document data 20 generated by the applications 21 from the operator, the host computer 16 executes a predetermined process on the document data 20 with the printer driver 22 and outputs the rendering command.

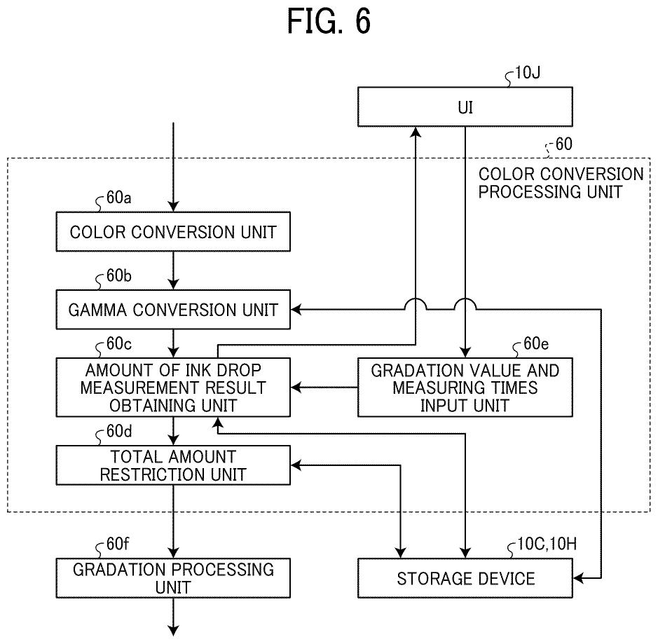

The information processing apparatus 10 includes a color conversion processing unit 60, a rendering processing unit 61, a buffer memory 62, and a page memory 63. The information processing apparatus 10 converts the rendering command received from the host computer 16 into print data that can be processed by the image forming apparatus 12. The color conversion processing unit 60 will be described in detail later with reference to FIG. 6. The rendering processing unit 61 converts the print data in a command format into image data in a raster format, and stores the image data in the buffer memory 62. The image data in the raster format stored in the buffer memory 62 is output from the page memory 63 as the print data.

FIG. 6 is a diagram illustrating a configuration of the color conversion processing unit 60 of the information processing apparatus 10. The color conversion processing unit 60 includes a color conversion unit 60a, a gamma conversion unit 60b, an amount of ink drop measurement result obtaining unit 60c, a total amount restriction unit 60d, and a gradation value and measuring times input unit 60e.

The color conversion unit 60a executes color conversion processing on color data included in the rendering command received from the host computer 16. The gamma conversion unit 60b executes gamma conversion processing on the color data on which the color conversion processing has been executed by the color conversion unit 60a.

The gradation value and measuring times input unit 60e obtains information on a measurement gradation value and the number of times of measurement. The measurement gradation value is a gradation value designated to measure the amount of ink drop to reproduce the color of the gradation value. The gradation value and measuring times input unit 60e may obtain the information on the measurement gradation value and the number of times of measurement input on the UI 10J.

The amount of ink drop measurement result obtaining unit 60c obtains a measurement result of the amount of ink drop based on the color data on which the gamma conversion processing has been executed before the total amount of ink drop is restricted, and the measurement gradation value and the number of times of measurement input by the gradation value and measuring times input unit 60e. In this way, the amount of ink drop that is addressed to the environment and changes over time is obtained with high accuracy. When a signal for starting a restriction on the total amount of ink drop is received, the amount of ink drop measurement result obtaining unit 60c instructs a measurement result obtaining unit included in, for example, the image forming apparatus 12 to measure the amount of ink drop, and obtains the measurement result of the amount of ink drop.

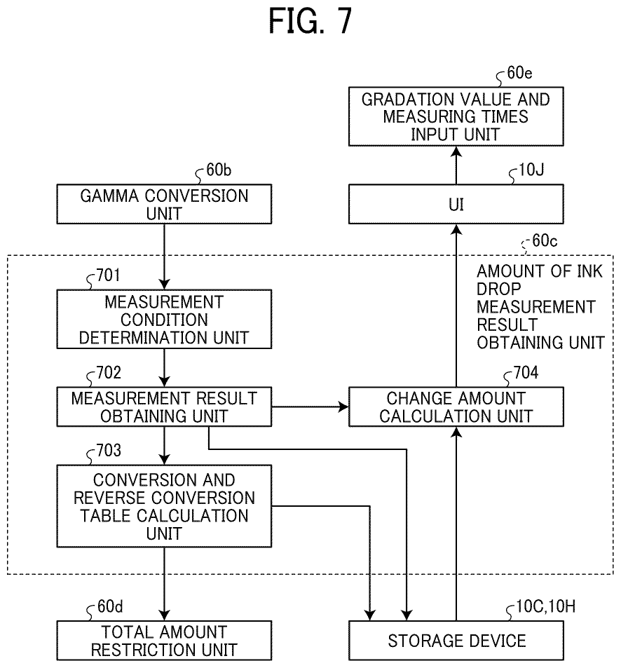

The total amount restriction unit 60d (an example of a total amount restriction unit) restricts the total amount of ink drop corresponding to the gradation value using a conversion table created by a conversion and reverse conversion table calculation unit 703 (see FIG. 7) described later. For example, a total amount of ink discharged from the ink head of the image forming apparatus 12 is controlled, according to a limit determined by the total amount restriction unit 60d.

A gradation processing unit 60f converts the amount of ink drop for which the total amount of ink drop has been restricted into a gradation value. In the present embodiment, the gradation processing unit 60f is provided outside the color conversion processing unit 60. Alternatively, the gradation processing unit 60f may be provided inside the color conversion processing unit 60.

FIG. 7 is a diagram illustrating a configuration of the amount of ink drop measurement result obtaining unit 60c of the information processing apparatus 10. As illustrated in FIG. 7, the amount of ink drop measurement result obtaining unit 60c includes a measurement condition determination unit 701, a measurement result obtaining unit 702, the conversion and reverse conversion table calculation unit 703, and a change amount calculation unit 704.

The measurement condition determination unit 701 obtains information on the measurement gradation value and the number of times of measurement from the gradation value and measuring times input unit 60e, and determines the measurement condition.

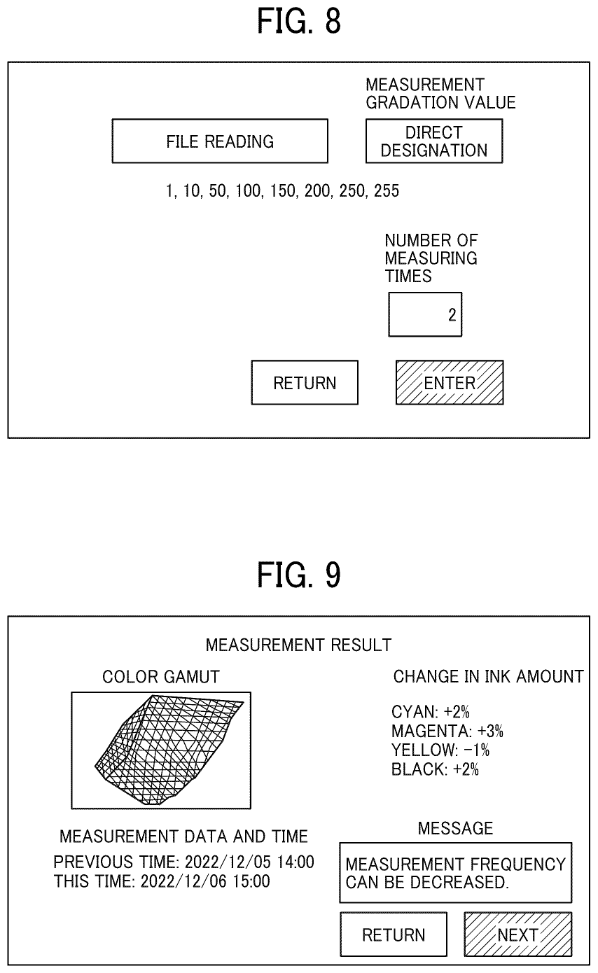

FIG. 8 is a diagram illustrating a method for specifying a measurement gradation value and the number of times of measurement in the information processing apparatus 10. As illustrated in FIG. 8, the measurement gradation value to be measured and the number of times of measurement are specified by the operator on the UI 10J. After the measurement gradation value is read from a file or specified directly, the measurement gradation value may be displayed on the UI 10J for confirmation. In FIG. 8, a case where 1, 10, 50, 100, 150, 200, 250, and 255 are specified as measurement gradation values.

Referring back to FIG. 7, the measurement result obtaining unit 702 (an example of a measurement result obtaining unit) obtains the measurement result of the amount of ink drop, and transmits the obtained measurement result (measurement data) of the amount of ink drop to the conversion and reverse conversion table calculation unit 703, the change amount calculation unit 704, and the storage device (e.g., the RAM 10C, the HDD 10H). As a method for measuring the amount of ink drop, for example, the following two methods are considered. One method is to detect the amount of ink drop discharged from each nozzle of an inkjet head with, for example, a sensor disposed at the nozzles of the inkjet head of the image forming apparatus 12. The other method is to discharge ink to a tray containing a liquid that prevents the ink from evaporating and measure the weight of the ink in the tray. In the present embodiment, the amount of ink drop is measured in the image forming apparatus 12.

The measurement result obtaining unit 702 obtains the measurement result of the amount of ink drop corresponding to any gradation value from 1 to 255. Alternatively, the measurement result obtaining unit 702 may obtain the measurement result of the amount of ink drop corresponding to a gradation value specified as the gradation value subjected to measuring on the UI 10J. Thus, the operator is allowed to determine the balance between the time and accuracy in measuring the amount of ink drop. The gradation value subjected to measuring may be specified by reading a text file in which the gradation values are listed and separated with, for example, commas, tabs, and spaces, or may be specified by the operator specifying the gradation values on the UI 10J.

Still alternatively, the measurement result obtaining unit 702 may obtain the measurement result of the amount of ink drop discharged from all the nozzles used in printing. In this way, the individual differences among the nozzles are reduced and the accuracy of the measurement result of the amount of ink drop increases. Due to individual differences of inkjet heads or nozzles of an inkjet head, even when ink is output in the same gradation, the same amount of ink is not necessarily discharged from all the nozzles. For this reason, taking into account variations among the nozzles of the inkjet head or among the inkjet heads in amount of ink discharged from the nozzles, the amount of ink discharged from the nozzles of all the inkjet heads or all the nozzles of the inkjet head used in printing is measured. In this way, the variations among the nozzles of the inkjet head or among the inkjet heads in amount of ink discharged from the nozzles are absorbed.

The measurement result obtaining unit 702 may obtain the measurement result of the amount of ink drop multiple times. At this time, the measurement result obtaining unit 702 may obtain the measurement result of the amount of ink drop for the number of times of measurement specified on the UI 10J (the number of times of measurement included in the measurement condition determined by the measurement condition determination unit 701). Thus, the operator is allowed to determine the balance between the time and accuracy in measuring the amount of ink drop.

The change amount calculation unit 704 calculates a difference from the previous measurement data and displays the result on a display such as the UI 10J.

FIG. 9 is a diagram illustrating display of the change in ink amount in the information processing apparatus 10. In the present embodiment, after the amount of ink drop is measured, the change amount calculation unit 704 (an example of a display control unit) displays, on the UI 10J, the change in ink amount, which is the difference between the measurement result of the amount of ink drop obtained this time and the measurement result of the amount of ink drop obtained previous time. In this way, the operator can experience the effect of measuring the amount of ink drop.

In this case, the change amount calculation unit 704 may display the color gamuts before and after measuring the amount of ink drop so that the change in ink amount can be visually recognized, or may indicate the change in ink amount of each color in a specific ratio. By informing the operator of the change in ink amount, the operator can experience the effect of measuring the amount of ink drop. In addition, the dates and times of the measurement of the previous measurement data and the current measurement data may be displayed.

Further, the change amount calculation unit 704 may display a message for determining the measurement condition for measuring the amount of ink drop next times on a display such as the UI 10J based on the change in ink amount. In this way, the operator is guided to actions next times.

The change amount calculation unit 704 displays the message on the UI 10J according to the magnitude of the change in ink amount and the time elapsed from the date and time of the measurement of the previous measurement data. For example, the change amount calculation unit 704 displays, on the UI 10J, a message indicating one of the contents in Table 1 below. In FIG. 9, a message in a case where the change in ink amount is small and the time elapsed from the date and time of the measurement of the previous measurement data is short is presented. The operator refers to the content of the message to determine, for example, the frequency of measurement, the measurement gradation value, and the number of times of measurement next times.

TABLE 1

| | TIME ELAPSED FROM | |
|---|---|---|
| CHANGE | DATA AND TIME OF | |
| IN INK | PREVIOUS | |
| AMOUNT | MEASUREMENT | CONTENTS IN MESSAGE |
| GREAT | LONG | INCREASE FREQUENCY |
| | | OF MEASUREMENT |
| SMALL | LONG | DECREASE FREQUENCY |
| | | OF MEASUREMENT |
| GREAT | SHORT | MAINTENANCE REQUIRED |
| | | FOR HEAD AND NOZZLES |
| | | INCREASE NUMBER OF |
| | | MEASUREMENT |
| | | GRADATIONS |
| | | INCREASE NUMBER |
| | | OF TIMES OF |
| | | MEASUREMENT |
| SMALL | SHORT | DECREASE FREQUENCY |
| | | OF MEASUREMENT |

The conversion and reverse conversion table calculation unit 703 (an example of a creation unit) creates a conversion table used for converting a gradation value into an amount of ink and a reverse conversion table used for converting an amount of ink into a gradation value based on the measurement data. The conversion table and the reverse conversion table are used by the total amount restriction unit 60d to restrict the total amount of ink drop. Alternatively, in the case where the measurement result obtaining unit 702 obtains the measurement results of the amount of ink drop multiple times, the conversion and reverse conversion table calculation unit 703 may create a conversion table based on the average value of the measurement result of the amount of ink drop obtained multiple times. In this way, the measurement error in amount of ink drop is prevented or minimized, and the accuracy of the measurement value of the amount of ink drop increases.

In the case where not all the gradation values from 1 to 255 are measured, the conversion and reverse conversion table calculation unit 703 interpolates the gradation values that are not measured to create a conversion table and a reverse conversion table. For example, it is assumed that the measurement results of the gradation values in increments of five, at 5, 10, 15, and so on are obtained. The conversion and reverse conversion table calculation unit 703 interpolates the gradation values at 1, 2, 3, 4, 6, and so on that have not been measured to calculate the amount of ink drop. As the interpolation method, for example, linear interpolation or spline interpolation may be used. The fewer the number of times of measuring the gradation value, the greater the difference between the actual amount of ink drop and the gradation value that has been measured may be. However, the advantage is that the time in measuring becomes shorter. Which one to prioritize depends on the situation.

As described above, according to the information processing apparatus 10 of the present embodiment, the amount of ink drop that is addressed to the environment and changes over time is obtained with high accuracy by actually measuring the amount of ink drop before the total amount of ink drop is restricted. Thus, the image quality greatly increases.

The program executed by the information processing apparatus 10 of the present embodiment is stored in advance in, for example, the ROM 10B and provided. The program executed by the information processing apparatus 10 of the present embodiment may be configured to be recorded in any computer-readable recording medium, such as a compact disc-read-only memory (CD-ROM), a flexible disk (FD), a compact disc-recordable (CD-R), or a digital versatile disc (DVD), in an installable or executable file format and provided as a computer program product.

Alternatively, the program executed by the information processing apparatus 10 of the present embodiment may be stored in a computer connected to a network such as the Internet so that the program can be downloaded through the network and provided. Still alternatively, the program executed by the information processing apparatus 10 of the present embodiment may be configured to be provided or distributed via a network such as the Internet.

The program executed by the information processing apparatus 10 of the present embodiment has a module structure including at least one of the above-described functional units such as the color conversion processing unit 60 and the rendering processing unit 61. As actual hardware, a processor such as the CPU 10A reads the program from the ROM 10B described above and executes the program to load the above-described functional units onto a main storage device and implements the color conversion processing unit 60 and the rendering processing unit 61.

Aspects of the present disclosure are, for example, as follows.

According to Aspect 1, an information processing apparatus includes a measurement result obtaining unit that obtains a measurement result of an amount of ink drop discharged from nozzles of an inkjet head in response to receiving a signal for starting a restriction on a total amount of ink drop, a creation unit that creates a table used for converting a gradation value into the amount of ink drop based on the measurement result of the amount of ink drop, and a total amount restriction unit that restricts the total amount of ink drop corresponding to the gradation value using the table.

According to Aspect 2, in the information processing apparatus of Aspect 1, the measurement result obtaining unit obtains the measurement result of the amount of ink drop discharged from all the nozzles used in printing.

According to Aspect 3, in the information processing apparatus of Aspect 1 or 2, the measurement result obtaining unit obtains the measurement result of the amount of ink drop corresponding to a desired gradation value.

According to Aspect 4, in the information processing apparatus of any one of Aspects 1 to 3, the measurement result obtaining unit obtains the measurement result of the amount of ink drop multiple times, and the creation unit creates the table based on an average value of the measurement result of the amount of ink drop obtained multiple times.

According to Aspect 5, in the information processing apparatus of Aspect 1 or 2, the measurement result obtaining unit obtains the measurement result of the amount of ink drop corresponding to a gradation value specified as the gradation value subjected to measuring on a user interface (UI).

According to Aspect 6, in the information processing apparatus of any one of Aspects 1 to 3, the measurement result obtaining unit obtains the measurement result of the amount of ink drop for the number of times of measurement specified on the UI.

According to Aspect 7, the information processing apparatus of any one of Aspects 1 to 6 further includes a display control unit that, after the amount of ink drop is measured, displays, on a display, the change in ink amount, which is the difference between the measurement result of the amount of ink drop obtained this time and the measurement result of the amount of ink drop obtained previous time.

According to Aspect 8, in the information processing apparatus of Aspect 7, the display control unit displays, on the display, a message for determining the measurement condition for measuring the amount of ink drop next times based on the change in ink amount.

According to Aspect 9, an information processing method executed by an information processing apparatus includes obtaining a measurement result of an amount of ink drop discharged from nozzles of an inkjet head in response to receiving a signal for starting a restriction on a total amount of ink drop, creating a table used for converting a gradation value into the amount of ink drop based on the measurement result of the amount of ink drop, and restricting the total amount of ink drop corresponding to the gradation value using the table.

According to Aspect 10, a non-transitory recording medium stores a plurality of program codes which, when executed by one or more processors, causes the one or more processors to perform a method including obtaining a measurement result of an amount of ink drop discharged from nozzles of an inkjet head in response to receiving a signal for starting a restriction on a total amount of ink drop, creating a table used for converting a gradation value into the amount of ink drop based on the measurement result of the amount of ink drop, and restricting the total amount of ink drop corresponding to the gradation value using the table.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The one or more memories include a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising circuitry configured to:
obtain a measurement result of an amount of ink drop discharged from one or more nozzles of an inkjet head in response to receiving a signal for starting a restriction on a total amount of ink drop;
create a table used for converting a gradation value into the amount of ink drop based on the measurement result of the amount of ink drop; and
restrict a total amount of ink drop corresponding to the gradation value using the table.

2. The information processing apparatus according to claim 1, wherein the circuitry is configured to obtain the measurement result of the amount of ink drop discharged from all nozzles used in printing.

3. The information processing apparatus according to claim 1, wherein the circuitry is configured to obtain the measurement result of the amount of ink drop corresponding to a desired gradation value.

4. The information processing apparatus according to claim 1, wherein the circuitry is configured to:
obtain the measurement result of the amount of ink drop a plurality of times; and
create the table based on an average value of the measurement results of the amount of ink drop.

5. The information processing apparatus according to claim 1, wherein the circuitry is configured to obtain the measurement result of the amount of ink drop corresponding to a specific gradation value specified on a user interface (UI).

6. The information processing apparatus according to claim 1, wherein the circuitry is configured to obtain the measurement result of the amount of ink drop for a number of times of measurement specified on a user interface (UI).

7. The information processing apparatus according to claim 1, wherein the circuitry is further configured to, after the amount of ink drop is measured, display, on a display, a change in ink amount, which is a difference between the measurement result of the amount of ink drop currently obtained and the measurement result of the amount of ink drop previously obtained.

8. The information processing apparatus according to claim 7, wherein the circuitry is configured to display, on the display, a message used for determining a measurement condition for measuring the amount of ink drop for a next time based on the change in ink amount.

9. An information processing method comprising:
obtaining a measurement result of an amount of ink drop discharged from one or more nozzles of an inkjet head in response to receiving a signal for starting a restriction on a total amount of ink drop;
creating a table used for converting a gradation value into the amount of ink drop based on the measurement result of the amount of ink drop; and
restricting a total amount of ink drop corresponding to the gradation value using the table.

10. A non-transitory recording medium storing a plurality of program codes which, when executed by one or more processors, causes the one or more processors to perform a method, the method comprising:
obtaining a measurement result of an amount of ink drop discharged from one or more nozzles of an inkjet head in response to receiving a signal for starting a restriction on a total amount of ink drop;
creating a table used for converting a gradation value into the amount of ink drop based on the measurement result of the amount of ink drop; and
restricting a total amount of ink drop corresponding to the gradation value using the table.
